(19) United States
(12) Patent Application Publication
(10) Pub. No.: US 2003/0003964 A1
(43) Pub. Date: Jan. 2, 2003

(54) Method and apparatus for selectively admitting messages to a mobile station

(76) Inventor: Gary T. Wroblewski, Flower Mound, TX (US)

Correspondence Address: ROBERT C. ROLNIK, NOKIA INC., 6000 CONNECTION DRIVE, MD 1-4-755, IRVING, TX, 75039, US

(21) Appl. No.: 09/893,767

(22) Filed: Jun. 27, 2001

(51) Int. Cl. H04M 1/00

(52) U.S. Cl. 455/567; 455/414; 455/560

(57) ABSTRACT

A system and method to provide a command sequence (101) to initiate a selection of a mood-ring. Such a method may permit the listing of available mood-rings (103) and highlighting (105) of a current or default mood-ring. Subsequent cursor movements (107) may be controlled by an input device. Detecting a signal to select (108) may, in fact, select a mood-ring such that further user-inputs may edit (109) aspects of that mood-ring. Any selection of a mood-ring may be followed by filtering (111) of received wireless messages, e.g. to admit messages from sources identified in a database of a mobile station.

### BACKGROUND

The invention relates generally to handling of received messages in a mobile station. More particularly, the invention relates to a method to reduce storage of received messages in non-volatile memory.

Maintaining a minimal number of distractions during activities of concentration is a growing concern in a society that provides immediate, and sometimes unsolicited, access to information via devices such as pagers, mobile telephones, personal digital assistants and similar wirelessly connected devices. Among the growing sources of such distraction are instant messages generated, e.g by short messaging systems (SMS) and the like, such as those found in Global System for Mobiles (GSM) wireless systems.

Wireless messages, such as SMS, may originate in a number of computing devices. Today, the bulk of such messages originate on mobile telephones. Consequently, a source address is associated with such messages that correspond to the telephone number of the sender. Frequently the telephone number is the full international formatted telephone number.

Occasionally messages arrive that have source addresses denoted by email addresses. There are many ways to identify source. However, the interconnectedness that is growing between wireless networks, e.g. digital cellular telephony networks, and the Internet, is anticipated to bring with it enormous growth in sourcing messages from the Internet or server computers. In addition, marketing messages may be directed in growing numbers to mobile devices.

U.S. Pat. No. 5,479,476 describes the use of profiles in mobile terminals whereby the user by means of a few key presses may change the alerting of the terminal in order to fit into the requirements of the environment. This is very convenient for the user when he moves from a noisy environment, e.g. factory or street, into a silent environment, e.g. a meeting room, a theatre, or a restaurant. The users highly appreciate these profiles.

Current mobile telephones have databases to store contact details of people, companies and services that are useful to the user of the mobile telephone. The databases, including the phone-book of electronic entries available in Nokia mobile telephones, may store names, telephone numbers, and email addresses, among other information for each record. The database for storing such information may initially be empty, or be comprised of phone-book records that are not populated with information.

WO 01/39577 describes transferring electronic information to a terminal, preferably to a wireless terminal. Before transmission, a specific parameter intended for filtering is attached to the electronic information, with the help of which the electronic information is classified before it is delivered to a wireless terminal, and a receiving terminal is first informed of said parameter. On the basis of the parameter, the terminal either allows or prevents the receiving of said electronic information. The parameter may be included in the first part of the message, such as the header information, which the terminal first reads, and may, thus, leave the base part of the message un-received, wherein the actual electronic, on the basis of the parameter, will be prevented.

Those people thoroughly acquainted with Microsoft Outlook™ 98 can establish a rule-set for discarding incoming messages:

1) Select outlook;

2) Select a mail folder or ‘inbox’;

3) Select tools menu;

4) Select rules wizard;

5) Click ‘new’ button

6) ‘Next’

7) Select ‘From people or distribution list’

8) Select ‘From people or distribution list’ highlighted text

9) Navigate to list of people

10) Select at least one person

11) Click ‘from’

12) click ‘OK’

13) click ‘next’

14) select ‘delete it’

15) click ‘Finish’

16) Click ‘OK’

For someone who has never used the ‘rules wizard’ the foregoing sequence may be interlaced with occasional selections of ‘help’ buttons or other electonic guides—thus driving the process to about 20 steps for an average user. The ‘rules wizard’ menu item exists as a secondary menu choice in a menu tree of about seven menus, and 51 sub-menus. Needless to say, lengthy sub-menus and pick-lists fare poorly on mobile stations in terms of conveying to users how to access a function. This occurs because the context for mobile station is often a non-desk environment, where rapid communication is essential, and access to detailed manuals is seldom available or wanted.

### SUMMARY

A method according to an embodiment is shown for admitting a wireless message received at a mobile station based on a phone-book record. A choice of a mood-ring is received, wherein the mood-ring matches a first data or mood-ring instance stored in the phone-book record. A wireless message may be available having a content indicator. The wireless message may be admitted to, e.g. non-volatile memory, provided that the content indicator matches a second data or source identifier stored in the phone-book record, such as, e.g. a name or a number.

A routine selection of a mood-ring filter may be accomplished in three steps or fewer from an idle, or default state of a mobile station user interface, given that at least one entry is stored in a phone-book record of the mobile station. At this level of complexity, a manual may be kept simple, and training of users of mobile-stations may occur by way of word-of-mouth.

These and other features, aspects, and advantages of embodiments of the present invention will become apparent with reference to the following description in conjunction with the accompanying drawings. It is to be understood, however, that the drawings are designed solely for the purposes of illustration and not as a definition of the limits of the invention, for which reference should be made to the appended claims.

### BRIEF DESCRIPTION OF THE DRAWINGS

The present invention is further described in the detailed description which follows in reference to the noted plurality of drawings by way of non-limiting examples of preferred embodiments of the present invention in which like reference numerals represent similar parts throughout the several views of the drawings and wherein:

FIG. 1 is a diagram showing a process of editing or selecting a mood-ring to be applied on incoming messages according to an embodiment;

FIG. 2 shows a process of associating a phone-book entry with a mood-ring according to an embodiment; and

FIG. 3 shows a block diagram according to an embodiment.

### DETAILED DESCRIPTION

A mood-ring may be a collection of criteria, wherein a criteria is given by at least one database record bearing source addresses or contact information. Such a database record may include phone-book entry of a mobile station. Such a collection may be the collective database records that match a first-tier criterion, such as belonging to a mood-ring.

A wireless message is a message received at a device by wireless means, where the device comprises a wireless transceiver attached to a message rending output device, and collectively, the wireless transceiver and messaging rendering output device are portable.

A mood-ring is one or more rules or criteria that determines what classes of messages to admit to non-volatile storage of a mobile station. The rules associated with the mood ring may be activated so that the rules are used by a processor when a message is received at the mobile station. Because the mood or situation of a user of a mobile station may change quickly and often, it is advantageous to minimize any keystrokes or other entries necessary to switch between mood-rings or add or remove a mood-ring from the set of mood-rings that are active or activated.

A mood-ring, to have any practical effect to admit wireless messages into non-volatile storage on a mobile station, must have at least one database record of the phone associated with the mood-ring. Such an association or correspondence between a database record and a mood-ring may be created or added at the creation of content for the database record, e.g. as by providing a default mood-ring correspondence to a default mood-ring. In this context, adding a mood-ring association to a database record may comprise changing an existing mood-ring association to a database record. This may be possible by setting on or more bits or other mood-ring instance in an appropriate data structure of the database record. Such a setting of bits may be a first record data mood-ring instance.

Alternatively, a mood-ring setting for a mood-ring entry of a database record may occur as a manufacturing step, wherein a preliminary content is added to a database record is a mood-ring or mood-ring instance. A database record may have multiple associations with multiple mood-rings, i.e. multiple mood-ring instances may correspond to a first record data. In addition, the mood-ring should be activated, or otherwise selected for use as a filtering criterion for wireless messages. Given these two prerequisites, a wireless message may arrive at the mobile station satisfying a matching criterion or other source indicator of a database record that is associated with the at least one mood ring that is active. Under that condition, the wireless message will be admitted to non-volatile memory, or stored in a manner resistant to power loss.

A mobile station may optionally emit a beep or other stimulus to indicate receipt of a message that has been admitted to non-volatile memory.

A list of mood-rings may be selected by entering a command, which may comprise the pressing of a menu softkey followed by a keypad button such as the ‘#’ key. The menu may display an initial listing as follows:

_Private

_Consumer (25)

X Information (25)

X Friends (25)

Table 1

There are a number of other ways to convey mood-ring indicators, however, as an example, a list of text formatted indicators shown in Table 1. Such a list may be displayed on a display of a mobile station. The list may include mood-ring indications as well as settings that denote the absence of a mood-ring. A mood-ring setting may be an all-or-nothing setting in the form of a ‘private’, which may be a name for a mood-ring setting, wherein the setting blocks all incoming messages. The all-or-nothing setting, may be in the form of ‘consumer’, which may be a name for a mood-ring setting that admits all incoming messages.

Selection of a mood-ring may occur by scrolling a cursor or other selection indicia through the list until the desired mood-ring indication is highlighted. Once a key-press signal is received, a mood-ring may be toggled active or inactive. A key-press signal may be generated by pressing a ‘select’ softkey. In addition, a field entry may be made using numeric key entry. The field may be associated with a maximum length of a list of messages kept in a queue for later review. Such a maximum length may operate as a threshold wherein a message older than the length setting may be automatically discarded. Memory may be freed for other purposes that may have been previously occupied by the message discarded.

Pressing a ‘set’ softkey may signal the completed entry to the field. Pressing a ‘check’ softkey may set any radio-button, and identify a mood-ring to be activated when receiving messages. Entries and changes to the list of mood-rings may be concluded by pressing an ‘exit’ softkey or the ‘end’ key. One or more presses of a softkey or other key may be a mood-ring selection command.

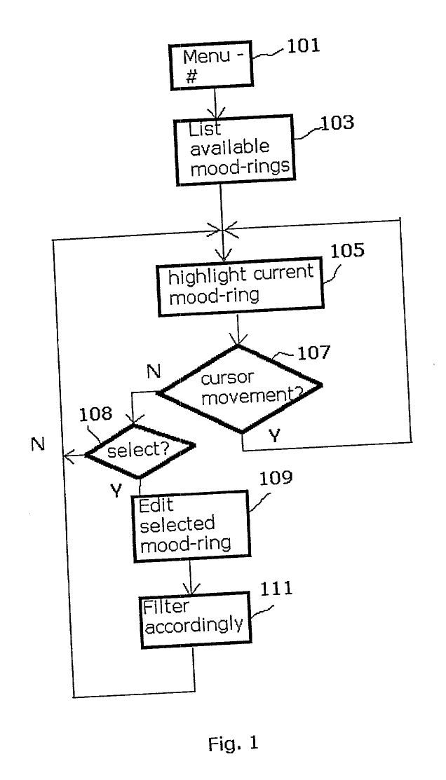

FIG. 1 shows a process by which a mood-ring may be selected, wherein such a mood-ring may also be coupled with a profile that governs the sound if any and type of alert a mobile station such as a mobile phone makes when a voice or other high-bandwidth communication arrives. A brief command sequence is entered 101, which may comprise keystrokes such as a soft-key followed reasonably closely by the ‘#’ key or other non-numeric key. The mobile station may present 103 a list or menu of named mood-rings, which may be associated with profiles. Alternatively, the mood-ring may be represented in the menu by a name shared with a profile. One of the names may be highlighted 105. If a user input, such as by pressing a cursor movement key is detected 107, then the process may return to highlight 105 a current mood-ring. Pressing a cursor movement key may cause a cursor movement signal. If a ‘select’ command occurs 108, e.g. by pressing a softkey, one or more fields relating to a mood-ring may be changed 109. For example, an edit of a mood-ring may include setting a size of a queue of messages to retain prior to discarding on a first-in-first-out basis. Thus highlighting a field that appears in parenthesis in Table 1 may navigate a cursor on a display such that character entries may set the maximum size. Entries of keystrokes when a cursor is in this context may provide a threshold setting signal. The ‘private’ setting has no maximum size, because there is no queue for receiving such messages since all messages are discarded or placed in a volatile memory. A setting of a maximum queue or threshold to 0 may make a mood-ring inactive to admit messages.

Concluding the edit of the selected mood-ring, a mobile station may store the changes for filtering 111 of messages in accordance with the mood-ring selections, i.e. the mobile station may use the chosen mood-ring. Processing may return to highlight the current mood-ring 105. The step of filtering 111 may be a series of steps that are invoked upon receipt of a message wherein the embodiment may determine if criteria for admitting the message is met. The embodiment may be said to be using the mood-ring to admit messages when such series of steps are invoked upon receipt of a message. One such step may be a step to determine if one phone-book record is associated with a selected mood-ring. A second such step may be to determine if the message matches or otherwise correlates with a field of the phone-book record.

If a mood-ring is coupled with a conventional profile, then the first among the mood-rings that are selected, will serve as a reference to the profile to be used for incoming voice or other high-bandwidth communications. Thus selection of a mood-ring, may also operate to select a profile.

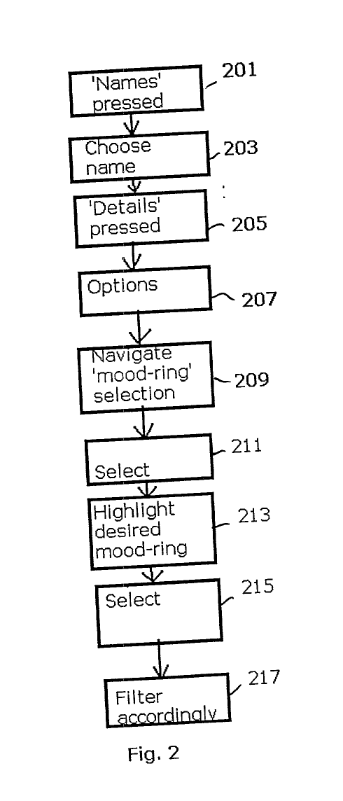

FIG. 2 shows a process by which an entry to a phone-book, including a source identifier, may be associated with a mood-ring or mood-ring instance. A ‘names’ softkey may be pressed 201 to begin look-up of a previously stored number or name which comprises part of a phone-book entry and may comprise a source identifier. When prompted, a user may enter one or more keys to select 203 a name from a list. A detailed view of the selected entry may be called for by selecting a ‘details’ softkey 205. Use of an ‘options’ softkey 207 may signal the interest to edit among other things, the mood-ring or first record data, if any, associated with the selected phone-book record. Each phone-book record may have a mood-ring setting, i.e. an association to at least one mood-ring. The mood-ring entry or data may contain a mere place-holder, such as null—signifying that a mood-ring is not yet associated with the phone-book record. If multiple options are presented, a navigation 209 may lead to a menu-entry of ‘mood-rings’. After receiving a select command 211, the embodiment may present a screen that includes allowed mood-ring groups that a phone-book record may be associated with. Using a navigation, the desired mood-ring group may be highlighted 213. Pushing a ‘select’ key 215 may match or associate the mood-ring entry or data of the phone-book record to the selected mood-ring, thus adding the phone-book record to a filter process 217, wherein at least one source identifier, such as a phone-number or other content indicator may be used as a criterion for admitting received messages. When the mobile station receives input from, e.g. the ‘select’ key, the mobile station may receive a command to associate or couple the mood-ring setting to a mood-ring.

The filter process may admit incoming messages on the basis of the presence, in a header of such message, of a source indicia that matches in some way, an entry within a phone-book record. A match between a source telephone found in a message and a phone number stored in a second record data of a phone-book record may be an admittance criterion. A match between a source email address and an email source address found in a message may be an admittance criterion.

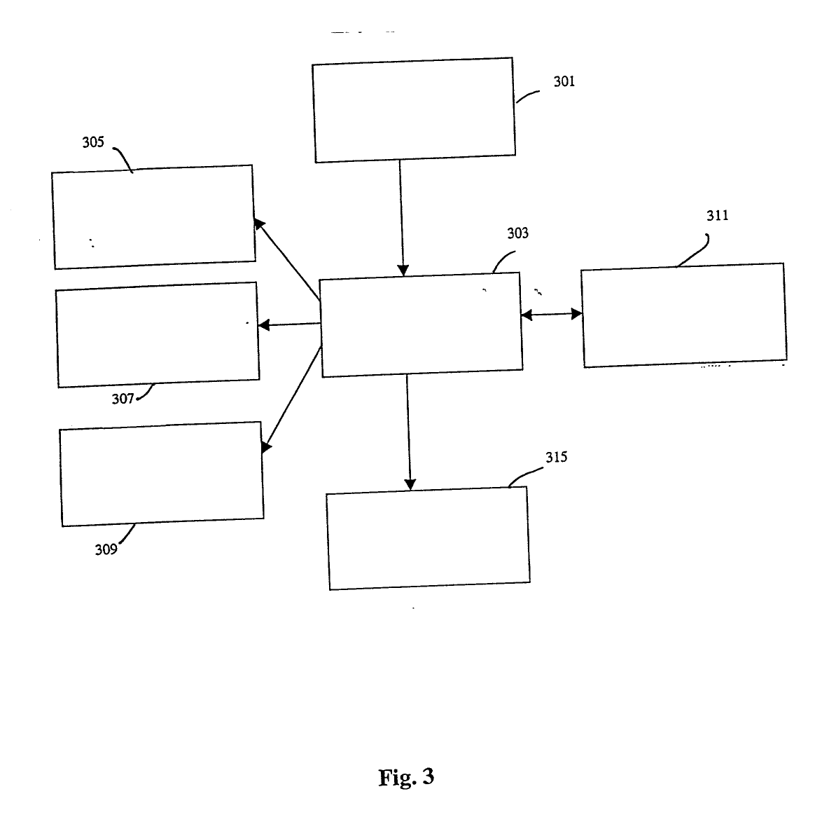

FIG. 3 shows a block diagram of a communication device or mobile station that may carry out the functions and equivalents described herein, such as, e.g. those of FIG. 1. A character-entry device or other input device 301 receives inputs. One or more portions or keys of the character entry device may be a command entry device, e.g. a ‘talk’ or ‘send’ marked key. Such inputs may be associated with characters, symbols and functions. The character-entry device may depend on pressure, e.g. such as to a keypad to take character and other inputs. Character-entry device may provide characters and other inputs encoded by means known in the art to an embedded processor 303. Embedded processor 303 may provide outputs that are discernable to human beings in several forms, including visual displays, audio, and vibrations, which may be provided by output devices such as a display screen 305, a speaker 307 or a vibrate motor 309 respectively. Display screen 305 may be a message rendering output device. Processor 303 may store and retrieve information from memory 311. Memory 311 may be preprogrammed with data and instructions. Memory 311 may be in a removable media. Communication device may be able to communicate with other devices through a transceiver 315. Transceiver may be a wireless transceiver. Transceiver 315 may be able to transmit and receive signals as electromagnetic signals or sound. At a minimum, transceiver 315 may be a transmitter. Transceiver 315 may be configured to receive messages addressed to it as a normal consequence of powering up or otherwise booting up the mobile station, wherein such messages arrive with sufficient power to be received without error.

Although described in the context of particular embodiments, it will be apparent to those skilled in the art that a number of modifications and various changes to these teachings may occur. For example, there are many alternative methods to receive commands at a mobile station, which may include pointing devices including location sensing devices, and sound recognition inputs. Thus, while the invention has been particularly shown and described with respect to one or more preferred embodiments thereof, it will be understood by those skilled in the art that certain modifications or changes, in form and shape, may be made therein without departing from the scope and spirit of the invention as set forth above and claimed hereafter.

What is claimed is:

1. A method for admitting a wireless message based on a phonebook record having a first record data mood-ring instance and a second record data source identifier comprising:
receiving a choice of a mood-ring to determine at least one chosen mood-ring said at least one chosen mood-ring matching the first record data mood-ring instance;
receiving a wireless message having a content indicator; and
admitting the wireless message provided that the content indicator matches the second record data source identifier and the at least one chosen mood-ring matches the first record data mood-ring instance.

2. The method for admitting of claim 1 further comprising:
adding a mood-ring association to the phone-book record, wherein the first record data mood-ring instance comprises the mood-ring.

3. The method for admitting of claim 2 wherein the step of adding a mood-ring comprises:
selecting the phone-book record, and
receiving a command to couple the phone-book record to the mood-ring.

4. The method for admitting of claim 3 wherein the step of selecting a phone-book record comprises:
listing a list of phone-book records; and
receiving a name choice matching a list of phone-book records.

5. The method for admitting of claim 2 wherein the step of adding comprises:
adding a criterion to the phone-book record, wherein the second record data source identifier comprises the criterion.

6. The method for admitting of claim 5 wherein the step of adding a criterion comprises:
adding a phone-number to the phone-book record.

7. The method for admitting of claim 6 wherein the step of adding a criterion comprises:
adding an address to the phone-book record.

8. A mobile station for admitting a wireless message based on a phone-book record having a first record data mood-ring instance and a second record data source identifier, said phone-book record stored in memory of the mobile station, comprising:
an input device for receiving a choice of a mood-ring to determine at least one chosen mood-ring, said at least one chosen mood-ring matching the first record data mood-ring instance, and for storing to memory;
a receiver for receiving a wireless message having a content indicator; and
a processor for admitting the wireless message provided that the content indicator matches the second record data source identifier.

9. The mobile station for admitting of claim 8 further comprising:
a means for adding a mood-ring association to the phone-book record, wherein the first record data mood-ring instance comprises the mood-ring.

10. The method for admitting of claim 9 wherein the step of adding a mood-ring comprises:
a second input device for selecting the phone-book record, and for receiving a command to associate the phonebook record to the mood-ring.

11. The mobile station for admitting of claim 10 wherein the step of selecting a phone-book record comprises:
a display for listing a list of phone-book records; and
a third input device for receiving a name choice matching a list of phone-book records.

12. The mobile station for admitting of claim 9 wherein the step of adding comprises:
a second input device for adding a criterion to the phonebook record, wherein the second record data source identifier comprises the criterion.

13. The mobile station for admitting of claim 12 wherein the step of adding a criterion comprises:
a third input device for adding a phone-number to the phone-book record.

14. The mobile station for admitting of claim 13 wherein the step of adding a criterion comprises:
a fourth input device for adding an address to the phonebook record.

15. A method for selecting a mood-ring comprising:
receiving a choice among at least one mood-ring wherein a chosen mood-ring is provided;
using the chosen mood-ring to admit at least one wireless message.

16. The method for selecting of claim 15 wherein the step of receiving comprises:
receiving a mood-ring selection command; and
listing at least one mood-ring indicator.

17. The method for selecting of claim 16 wherein the step of receiving further comprises:
highlighting a current mood-ring indicator; and
receiving a cursor movement signal; and
highlighting a second mood-ring indicator.

18. The method for selecting of claim 16 wherein the step of receiving further comprises:
editing the at least one mood-ring associated with the at least one mood-ring indicator.

19. The method for selecting of claim 16
receiving a key-press signal associated with a mood-ring selection command.

20. The method for selecting of claim 19 wherein the key-press signal comprises a threshold setting signal.

21. The method for selecting of claim 15 wherein the chosen mood-ring comprises profile data.
